(19) United States
(12) Patent Application Publication
(10) Pub. No.: US 2024/0020647 A1
(43) Pub. Date: Jan. 18, 2024

(54) METHOD OF MATCHING HUMAN RESOURCES

(71) Applicant: MIIDAS CO., LTD., Tokyo (JP)

(72) Inventor: Kietsu GOTO, Tokyo (JP)

(21) Appl. No.: 18/246,645

(22) PCT Filed: Sep. 22, 2021
(86) PCT No.: PCT/JP2021/034762

§ 371 Date: Sep. 19, 2023

(30) Foreign Application Priority Data
Sep. 24, 2020 (JP) 2020-160078

(51) Int. Cl. G06Q 10/1053

(52) U.S. Cl. CPC G06Q 10/1053

(57) ABSTRACT

The purpose is to increase the accuracy of matching job seekers and recruiters according to the needs of each of the recruiters. A method of matching a job seeker with a recruiter, wherein the server terminal provides an aptitude test to the job seeker terminal and the recruiter terminal; receives, from the recruiter's terminal and the job seeker's terminal, response information to the aptitude test; calculates a score for each recruiter associated with the recruiter terminal and each job seeker associated with the job seeker terminal based on the response information; responds to a search request for a job seeker from the recruiter's terminal; and extracts job seekers satisfying the predetermined conditions by referring to the job seeker's score based on the recruiter's score.

### TECHNICAL FIELD

This invention relates to a method of matching job seekers and recruiters.

### BACKGROUND ART

In the past, services related to matching job seekers (candidates for employment) and recruiters (companies hiring) using aptitude tests have become widespread, and it is common for aptitude tests to evaluate characteristics such as the personality and abilities of job seekers.

For example, Patent Literature 1 discloses a method of administering an aptitude test to a recruiter's employees and setting a job seeker's aptitude test goals based on the results of aptitude tests previously taken by highly rated employees in the company.

### PRIOR ART LIST

### Patent Literature

[Patent Literature 1] JP2010015289A

### SUMMARY OF THE INVENTION

### Technical Problem

However, although Patent Literature 1 makes it possible to improve the accuracy of job matching between job seekers and recruiters by using aptitude tests, in fact, the image of human resources that recruiters seek differs from recruiter to recruiter. Therefore, it is not always appropriate to set aptitude test targets according to predetermined rules.

Therefore, the purpose of this invention is to improve the accuracy of matching job seekers and recruiters according to the needs of each of the recruiters.

### Technical Solution

In one embodiment of the invention, a method of matching a job seeker and a recruiter provided by a system having a recruiter terminal associated with a recruiter, a job seeker terminal associated with a job seeker connected to the recruiter terminal via a network, and a server terminal. The server terminal provides an aptitude test to the job seeker terminal and the recruiter terminal, receives response information to the aptitude test from the job seeker terminal and the recruiter terminal. Furthermore, based on the response information, the server calculates each score of a recruiter associated with the recruiter terminal and a job seeker associated with the job seeker terminal, and in response to a search request for job seekers from the recruiter terminal, the server extracts the job seekers that meet the predetermined conditions by using the score of the job seeker as a reference.

### Advantageous Effects

According to this invention, it is possible to achieve a higher matching accuracy between job seekers and recruiters in accordance with the needs of each of the recruiters.

### BRIEF DESCRIPTION OF THE DRAWINGS

FIG. 1 shows a block diagram showing a matching system, in accordance with the first embodiment of this invention.

FIG. 2 shows a functional block diagram showing the server terminal 100 of FIG. 1.

FIG. 3 shows a functional block diagram showing the job seeker terminal 200 of FIG. 1.

FIG. 4 shows an example of job seeker data stored on the server 100.

FIG. 5 shows an example of recruiter data stored on the server 100.

FIG. 6 shows an example of a flowchart for a matching method, according to the first embodiment of this invention.

FIG. 7 shows another example of a flowchart pertaining to a matching method in accordance with the first embodiment of this invention.

FIG. 8 shows yet another example of a flowchart pertaining to a matching method, in accordance with the first embodiment of this invention.

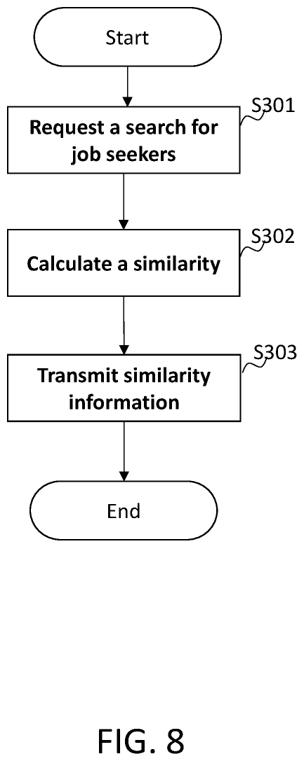

FIG. 9 shows an example of a screen showing information pertaining to a recruiter and a job seeker displayed at a job seeker terminal and a recruiter terminal, respectively.

FIG. 10 shows an another example of a screen showing information pertaining to a recruiter and a job seeker displayed at a job seeker terminal and a recruiter terminal, respectively.

FIG. 11 shows an example of a flowchart pertaining to a matching method in accordance with the second embodiment of this invention.

### DETAILED DESCRIPTION OF THE EMBODIMENTS

Embodiments of this invention will be described below with reference to the drawings. The embodiments described below do not unduly limit the contents of this disclosure as set forth in the claims. Not all of the components shown in the embodiments are essential components of this disclosure.

### Embodiment 1

### <Configuration>

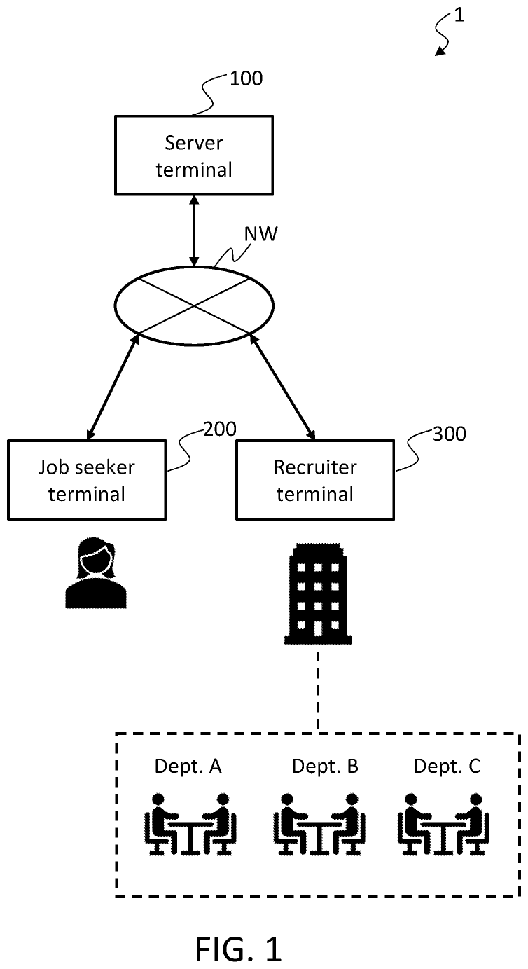

FIG. 1 is a block diagram of a matching system according to the first embodiment of this invention. The system 1 comprises a job seeker terminal 200 associated with job seekers from various backgrounds, a recruiter terminal 300 associated with recruiters, such as companies, conducting recruitment activities, and a server terminal 100 that mediates the two.

The server terminal 100 is connected to the job seeker terminal 200 and the recruiter terminal 300 via a network NW. The network NW comprises the Internet, an intranet, a wireless LAN (Local Area Network) or WAN (Wide Area Network), etc.

The server terminal 100 provides aptitude tests to employees of recruiter companies and job seekers, and analyzes the aptitude of the employees of recruiter companies and job seekers from the responses obtained, accepts information related to the recruiter from the recruiter through the recruiter terminal 300, and from the job seeker through the job seeker terminal 200, and is a device that performs the matching process between recruiters and job seekers based on the information related to job seekers. For example, it may be a general-purpose computer such as a workstation or personal computer, or it may be logically realized by cloud computing. In this embodiment, one server terminal is shown for convenience of explanation, but it is not limited to this and may be multiple.

Job seeker terminal 200 is an information processing device, such as a personal computer or tablet terminal, owned by a job seeker who wishes to find a job or change jobs and use the services provided by server terminal 100, but it may also comprise a smartphone, cell phone, PDA, etc.

The recruiter terminal 300 is an information processing device, such as a personal computer or tablet terminal, owned by a recruiter (e.g., a person in charge of hiring) who conducts recruiting activities and provides information related to the recruiter and uses the services provided by the server terminal 100. The server terminal 100 may also comprise a smart phone, cell phone, PDA, or the like. The recruiter company has one or more departments (e.g., department A, department B, department C, etc.), and each department has one or more employees. An aptitude test is provided to each of the employees in each of these departments by the server terminal 100, in some cases via the recruiter terminal 300. The aptitude test can also be provided by a server separate from the server terminal 100.

In this embodiment, the system 1 comprises a server terminal 100, a job seeker terminal 200, and a recruiter terminal 300, with the job seeker or recruiter respectively using the job seeker terminal 200 and the recruiter terminal 300 to perform operations on the server terminal 100. However, the server terminal 100 may comprise a stand-alone system, and the server terminal itself may be equipped with functions for job seekers or recruiters to perform operations.

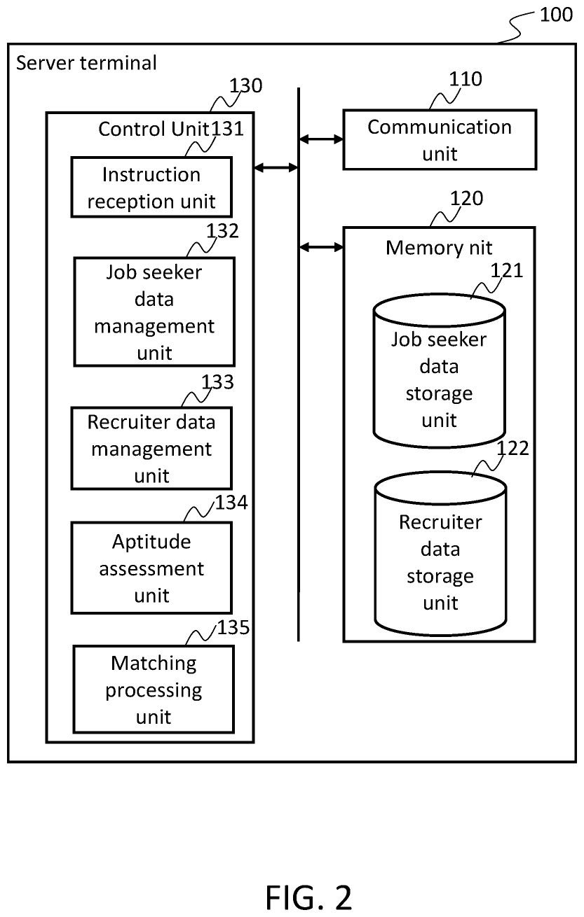

FIG. 2 is a functional block diagram of the server terminal 100 of FIG. 1. The server terminal 100 has a communication unit 110, a memory unit 120, and a control unit 130.

Communication unit 110 is a communication interface for communicating with job seeker terminal 200 and recruiter terminal 300 via the network NW, using communication protocols such as TCP/IP (Transmission Control Protocol/Internet Protocol).

The memory unit 120 stores programs for executing various control processes and each function in the control unit 130, input data, etc., and comprises RAM (Random Access Memory), ROM (Read Only Memory), etc. The memory unit 120 also has a job seeker data storage unit 121 for storing various data related to job seekers, a recruiter data storage unit 122 for storing various data related to job seekers, and the like. Furthermore, the memory unit 120 can also temporarily store data communicated with the job seeker terminal 200 and the recruiter terminal 300. A database (not shown) storing various data may be constructed outside the memory unit 120 or the server terminal 100.

The control unit 130 controls the overall operation of the server terminal 100 by executing a program stored in the memory unit 120, and comprises a CPU (Central Processing Unit), GPU (Graphics Processing Unit), or the like. The functions of the control unit 130 include an instruction reception unit 131 that accepts input from the job seeker terminal 200 or the recruiter terminal 300, a job seeker data management unit 132 that refers to and processes various data related to job seekers, a recruiter data management unit 133 that refers to and processes various data related to recruiters, and an aptitude assessment unit 134 that analyzes aptitude test answers entered by job seekers and employees of the recruiter company and calculates analysis results, and a matching processing unit 135 processes the matching of job seekers and recruiters. The instruction reception unit 131, job seeker data management unit 132, recruiter data management unit 133, aptitude assessment unit 134, and matching processing unit 135 are activated by a program stored in the memory unit 120 and executed by the server terminal 100, which is a computer (electronic computer).

The instruction reception unit 131 is provided by the server terminal 100 and receives instructions from the job seeker terminal 200 or the recruiter terminal 300 via the communication unit 110 when a user who is a job seeker or a recruiter makes a predetermined input via a user interface such as a screen displayed via a web browser or an application (click, tap, swipe, enter keywords, press an icon, etc.).

Job seeker data management unit 132 manages and processes various data related to job seekers (e.g., job seeker ID, basic job seeker information, background information, qualification information, desired condition information, and aptitude information).

Recruiter data management unit 133 manages and processes various data related to recruiters (e.g., recruiter ID, basic information, job information, aptitude information, etc.).

The aptitude assessment unit 134 analyzes the aptitude of job seekers and employees of the recruiter company based on the responses of job seekers and employees of the recruiter company entered from the job seeker terminal 200 and the recruiter terminal 300 (or the terminals of employees of the recruiter company) to the aptitude test provided, and calculates the results of the analysis.

The matching processing unit 135 performs processing to generate and provide information that supports matching to the job seeker terminal 200 and recruiter terminal 300 based on the assessment results of the aptitude test of the job seeker and the employees of the recruiter company.

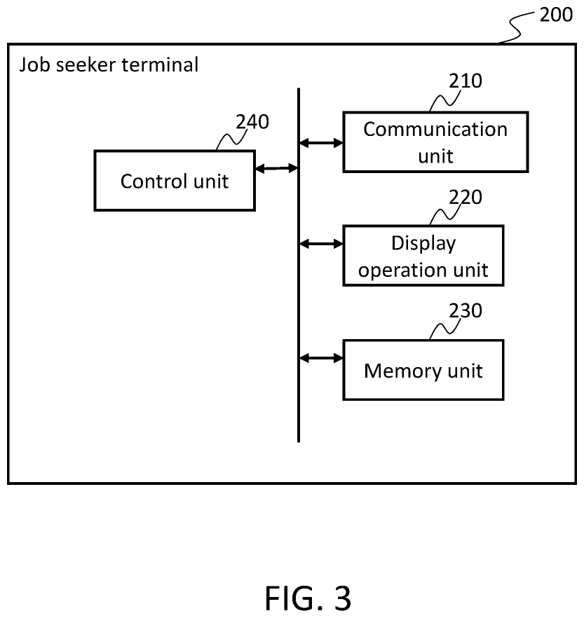

FIG. 3 is a functional block diagram showing the job seeker terminal 200 of FIG. 1. Job seeker terminal 200 comprises a communication unit 210, a display operation unit 220, a memory unit 230, and a control unit 240.

The communication unit 210 is a communication interface for communicating with the server terminal 100 via the network NW, for example, using communication protocols such as TCP/IP.

The display operation unit 220 is a user interface used by job seekers to input instructions and display text, images, etc. in response to input data from the control unit 240. When the job seeker terminal 200 comprises a personal computer, it comprises a display and a keyboard or mouse. When the job seeker terminal 200 comprises a smartphone or tablet terminal, it comprises a touch panel or the like. The display operation unit 220 is activated by a control program stored in the memory unit 230 and executed by the job seeker terminal 200, which is a computer (electronic computer). Through the display operation unit, the job seeker can press the keyboard, move the cursor with the mouse, tap, swipe, pinch, etc., on the provided aptitude test, in the case of a keyboard, in the case of a mouse, and in the case of a touch panel, respectively.

The memory section 230 stores programs, input data, etc. for executing various control processes and each function in the control section 240, and comprises RAM, ROM, etc. The memory unit 230 also temporarily stores the contents of communication with the server terminal 100.

The control unit 240 controls the overall operation of the job seeker terminal 200 by executing a program stored in the memory unit 230, and comprises a CPU, GPU, or the like.

The server terminal 100 may be configured to have the function of a display operation unit. In this case, the job seeker terminal 200 may not be provided.

The functional configuration of the recruiter terminal 300 is also substantially the same as that of the job seeker terminal 200, so an explanation will be omitted.

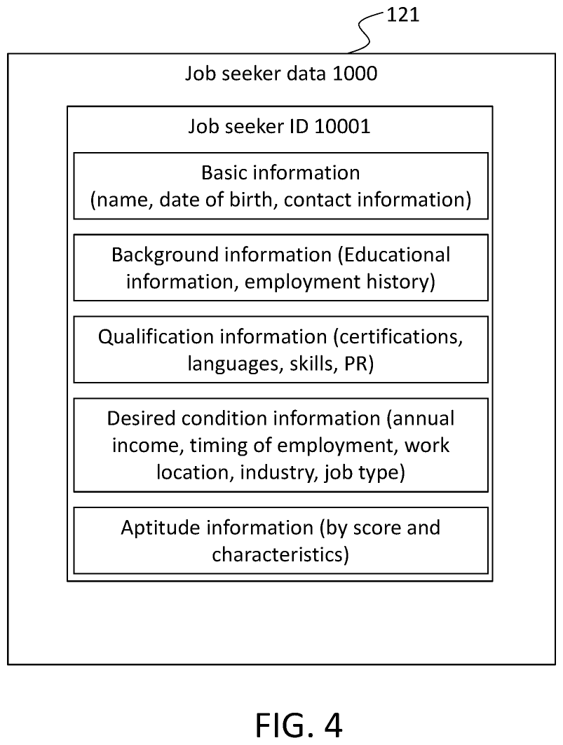

FIG. 4 shows an example of job seeker data stored on the server 100.

The job seeker data 1000 shown in FIG. 4 stores various data related to job seekers. In FIG. 4, for convenience of explanation, an example of one job seeker (the job seeker identified by the job seeker ID “10001”) is shown, but information on multiple job seekers can be stored. Various data related to a job seeker can be stored, for example, basic information about the job seeker (job seeker's name, address, contact information such as e-mail address, other SNS account information, etc.), background information (job seeker's educational background, employment history, recent annual income, etc.), qualification information (qualifications, languages, skills, and personal PR), desired information (desired annual salary, desired time of employment, desired place of work, desired industry, desired type of business, etc.), and aptitude information (aptitude test scores, scores by characteristics measured by aptitude tests (problem solving, quick thinking, logical thinking, decision making, management, perseverance, personality, etc.), etc.)

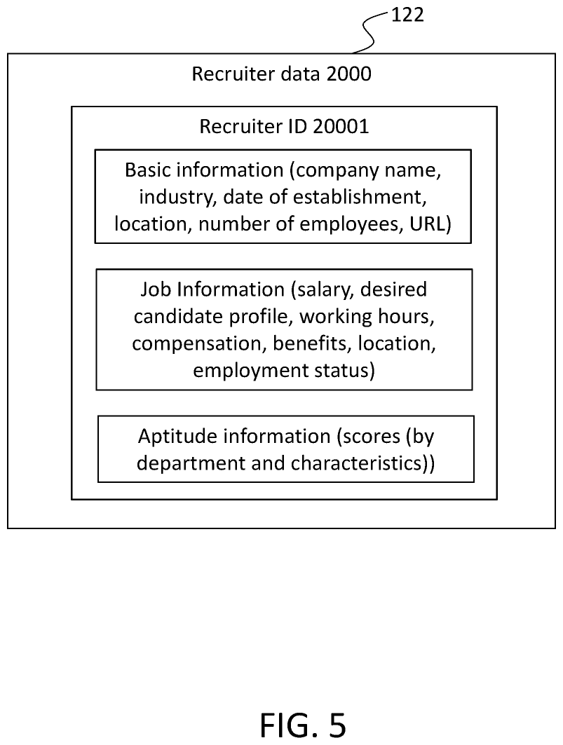

FIG. 5 shows an example of recruiter data stored on the server 100.

Recruiter data 2000, shown in FIG. 5, stores various data related to recruiters. In FIG. 5, for convenience of explanation, an example of one recruiter (the recruiter identified by the recruiter ID “20001”) is shown, but information on multiple users can be stored. For example, the following data related to a recruiter can be stored: basic information about the recruiter (company name, industry, date of establishment, location, number of employees, company website URL, company introduction, etc.), job information (salary, desired candidate profile, working hours, compensation, benefits, work location, employment status (regular employee (new graduates and mid-career), contract employee, intern, part-time employee, etc.), and other information).), and aptitude information (aptitude test scores of employees belonging to the recruiter's company (company-wide, by department, etc.), and scores by characteristics measured by the aptitude test (problem solving, quick thinking, logical thinking, decision-making, management, perseverance, personality, etc.), etc.).

<Process Flow>>

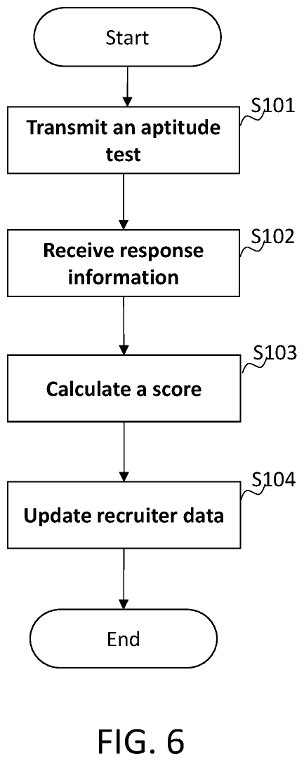

With reference to FIG. 6, the process flow of the matching method between job seekers and recruiters executed by the system 1 of this embodiment will be described. FIG. 6 is an example of a flow chart for the matching method, in accordance with the first embodiment of this invention.

To use this system 1, a job seeker and/or a recruiter (or an employee of a recruiter company) accesses the server terminal 100 using a web browser or an application, etc. at each of the job seeker terminal 200, the recruiter terminal 300 (or the respective terminals of employees belonging to one of the departments of the recruiter company). If this is the first time to use the service, the job seeker and recruiter must enter the aforementioned basic information and basic information, respectively. If the job seeker and recruiter have already obtained an account, they can log in by entering their ID and password, for example, to receive the prescribed authentication. After this authentication, a predetermined user interface is provided via a website, application, etc., and the process proceeds to step S101 shown in FIG. 6. For convenience of explanation, each of the recruiter's company recruiter's terminal and each of the employees belonging to one of the departments of the recruiter's company will be collectively referred to as “recruiter” and each person's terminal will be collectively referred to as “recruiter's terminal” unless otherwise specified.

First, in step S101, the server terminal 100 transmits the aptitude test to the recruiter terminal 300 via the communication unit 110. For example, the questions provided as an aptitude test are displayed on the user interface provided via a web browser or application on the recruiter terminal 300.

Questions provided as an aptitude test include, for example, a game to measure the respondent's aptitude. Through the game task, respondents can select and move objects displayed on the user interface in relation to the questions on the aptitude test by pressing the keyboard if the display control unit is a keyboard, or by using the mouse if the display control unit is a mouse. In the case of a touch panel, the object can be selected by tapping it, moved with a tap, or moved by swiping. Respondents can also perform text or voice input via the display controls in relation to the questions. The aptitude test is designed to measure multiple characteristics of respondents (e.g., problem solving, quick thinking, logical thinking, decision-making, management, perseverance, and personality) and can comprise multiple questions. Here, a single question can be tied to a specific characteristic or to multiple characteristics. The aptitude test can be used to evaluate the above characteristics by measuring the speed, accuracy and/or characteristics of the respondent's operation. The aptitude test can also be provided to respondents via paper media. The aptitude test is not limited to games, but can also be used to measure a respondent's aptitude by providing the respondent with a virtual reality space via an HMD (head-mounted display) or other means, or by measuring aptitude through other behavioral indexes.

Next, as the process of step S102, the server terminal 100 receives response information from the recruiter terminal 300 in response to the predetermined questions that were sent. For example, the instruction reception unit 131 of the control unit 130 of the server terminal 100 receives the response information from the recruiter terminal 300 via the communication unit 110.

Here, the response information can include keyboard, mouse and/or touch panel operation information and/or text or voice input information by the respondent. In addition to the operation information, the response information can also include behavioral information, such as the respondent answering multiple questions in succession.

Next, as the process of step S103, the server terminal 100 calculates a score regarding the recruiter's aptitude based on the response information received from the recruiter's terminal 300 for the aptitude test questions. For example, the aptitude assessment unit 134 of the control unit 130 of the server terminal 100 calculates a score regarding the recruiter's aptitude (comprising one or more characteristics) for the response information entered by the recruiter for each question.

For example, based on the respondent's response information, the aptitude assessment unit 134 can calculate a score for each of the multiple questions based on the correctness of the operational information and/or the characteristics, etc., and can calculate an overall score and/or a score by characteristic. For example, a score of 80/100 for “problem-solving skills” and 60/100 for “management skills” can be calculated for each characteristic for a given respondent. The total score can also be calculated by summing the scores for each characteristic. Furthermore, for example, a score of 80/100 for “perseverance” can be calculated based on the behavioral information that the respondent answered multiple questions in a row. The average, highest, and lowest scores for the recruiter's company as a whole and for employees in a specific department of the recruiter's company can also be calculated as statistical information. Furthermore, the above statistical information can be calculated for each group of employees in a particular department by dividing the group into high performers (employees who are highly rated in that department) and low performers (employees who are low rated in that department).

Next, as the process of step S104, the recruiter data management unit 133 of the server terminal 100 updates the recruiter data 2000 stored in the recruiter data storage unit 122 of the storage unit 120 for the aptitudes analyzed by the aptitude assessment unit 134 as described above.

As described above, the system can manage and update information on the suitability of recruiters as a pre-processing step in the matching process between job seekers and recruiters.

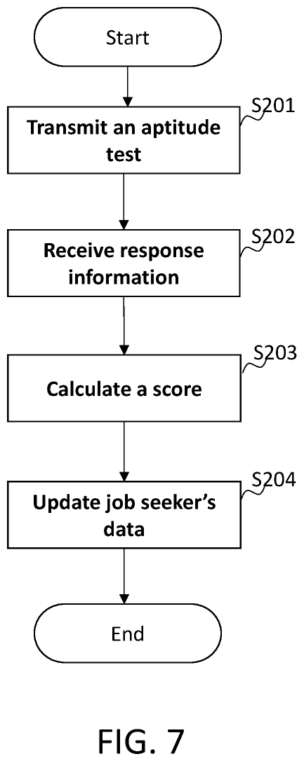

FIG. 7 is another example of a flowchart for a matching method, in accordance with the first embodiment of this invention.

As another example, the process of providing an aptitude test to job seeker terminal 200 by server terminal 100, and managing and updating information on job seeker aptitude is described below.

First, in step S201, the server terminal 100 transmits the aptitude test to the job seeker terminal 200 via the communication unit 110. For example, the questions provided as an aptitude test are displayed on the user interface provided via a web browser or application on the job seeker terminal 200.

The questions provided as an aptitude test are the same as those provided to recruiters, e.g., a game to measure the respondent's aptitude. For games, respondents can select and move objects displayed on the user interface in relation to the aptitude test questions by pressing the keyboard if the display control unit is a keyboard, or by using the mouse if the display control unit is a mouse. In the case of a touch panel, the object can be selected by tapping it, moved with a tap, or moved by swiping. Respondents can also perform text or voice input via the display controls in relation to the questions. The aptitude test is designed to measure multiple characteristics of respondents (e.g., problem solving, quick thinking, logical thinking, decision-making, management, perseverance, and personality) and can comprise multiple questions. Here, a single question can be tied to a specific characteristic or to multiple characteristics. The aptitude test can be used to evaluate the above characteristics by measuring the speed, accuracy and/or characteristics of the respondent's operation. The aptitude test can also be provided to respondents in paper media.

Next, as the process of step S202, the server terminal 100 receives response information from the job seeker terminal 200 in response to the predetermined questions that were sent. For example, the instruction reception unit 131 of the control unit 130 of the server terminal 100 receives the response information from the job seeker terminal 200 via the communication unit 110.

The response information can include keyboard, mouse and/or touch panel operation information and/or text or voice input information by the respondent in the same manner as above. In addition to the operation information, the response information can also include behavioral information such as the respondent answering multiple questions in succession.

Next, as processing of step S203, the server terminal 100 calculates a score regarding the job seeker's aptitude based on the response information received from the job seeker terminal 200 for the aptitude test questions. For example, the aptitude assessment unit 134 of the control unit 130 of the server terminal 100 calculates a score regarding the job seeker's aptitude (comprising one or more characteristics) for the response information entered by the recruiter for each question.

For example, based on the respondent's response information, the aptitude assessment unit 134 can calculate a score for each of the multiple questions based on the correctness of the operational information and/or the characteristics, etc., and can calculate a total score and/or a score by characteristic. For example, a score of 80/100 for “problem solving skills” and 60/100 for “management skills” can be calculated for a given respondent. In addition, an overall score can be calculated by summing the scores for each characteristic. Furthermore, for example, a score of 80/100 for “perseverance” can be calculated based on the behavioral information that the respondent answered multiple questions in a row.

Next, as the process of step S204, the job seeker data management unit 132 of the server terminal 100 updates the job seeker data 1000 stored in the job seeker data storage unit 121 of the storage unit 120 for the aptitudes analyzed by the aptitude assessment unit 134 as described above.

As described above, the system can manage and update information on the suitability of job seekers as a pre-processing step in the matching process between job seekers and recruiters.

FIG. 7 is yet another example of a flowchart for a matching method, in accordance with the first embodiment of this invention.

As yet another example, the process by which the server terminal 100 provides information to the recruiter terminal 300 regarding the similarity of job seekers to a particular department is described below.

First, in step S301, the instruction reception unit 131 of the server terminal 100 receives, via the communication unit 110, a request to search about job seekers from the recruiter's terminal 300. For example, through the user interface of the recruiter terminal 300, the recruiter enters the name of a specific department of the recruiter and makes a request to search for job seekers matching that department by a predetermined operation.

Next, as the process of step S302, the aptitude assessment unit 134 of the server terminal 100 calculates the similarity of the job seeker's aptitude for employees in the specific department of the job seeker. For example, the aptitude assessment unit 134 refers to the aptitude information about employees in a specific department entered by the job seeker from the job seeker data 2000 in the job seeker data storage unit 122, and extracts the aptitude information for employees in that department. Here, the extracted aptitude information includes the score for each employee in the department, and may also include a score for each characteristic, or an overall score as the sum or average of the scores for each characteristic. Here, the score may be the average, highest, and/or lowest score for the department. The aptitude information also includes scores for each of the high and low performer groups. Similarly, for example, the aptitude assessment unit 134 refers to the aptitude information for all or some job seekers from the job seeker data 1000 in the job seeker data storage unit 121 and extracts the aptitude information for each job seeker. The extracted aptitude information may include a job seeker's score for each characteristic, or an overall score as the sum of scores for each characteristic. Then, the aptitude assessment unit 134 compares, for example, the average score for each characteristic of each job seeker with the average score for the above-mentioned department by characteristic, and calculates the similarity of the scores for each characteristic. For example, if the average score of Department A of Company X for the characteristic “problem-solving skills” is 100, and a job seeker's score for that characteristic is 60, the similarity is calculated as 60%. Alternatively, the aptitude assessment unit 134 may, for example, contrast the overall score of the above-mentioned department with the overall score of each job seeker and calculate the similarity of the overall scores.

Next, as the process of step S303, the matching processing unit 135 of the server terminal 100 transmits the information on the calculated similarity to the recruiter terminal 300.

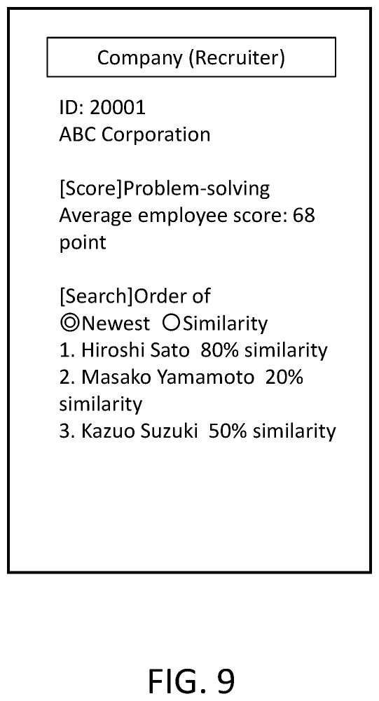

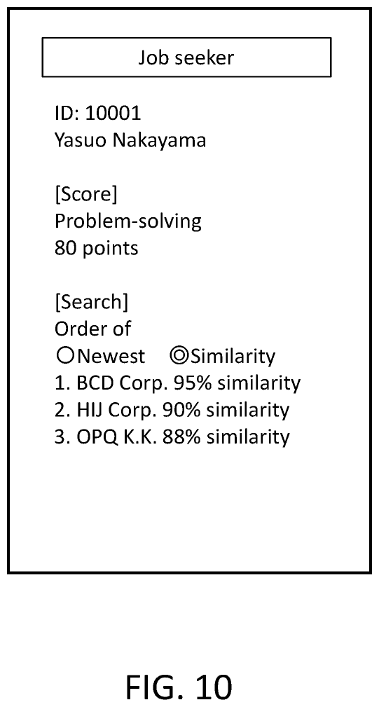

FIG. 9 and FIG. 10 show examples of screens displayed on each of the job seeker and recruiter terminals showing information pertaining to the recruiter and job seeker.

As shown in FIG. 9, information on the similarity of job seekers to a specific department of a recruiter is displayed on the user interface of the recruiter terminal 300, either by characteristics of a specific department (employee group) of the recruiter company or by all characteristics as a whole. For example, for a group of employees in the recruiter's sales department, information on multiple job seekers is displayed, each with similarity information for the “problem-solving” characteristic. The job seeker information can be sorted and displayed, for example, in order of most recent or similarity. The similarity is based on a comparison of each job seeker's score to the average score of a group of employees in the sales department for the characteristic “problem-solving skills”. It should be noted that a job seeker with a high degree of similarity with respect to “problem-solving skills” is not necessarily a match (i.e., a good fit) for that department. The feature of this embodiment is that among multiple characteristics, the decision as to which characteristic's similarity to base the approach to suitable job seekers on is ultimately left to the discretion of the hiring personnel of that department. For example, if a company does not emphasize “problem-solving skills” in its sales department, and on the other hand, the company emphasizes “perseverance,” the hiring manager in that department may select and approach job seekers who are highly similar in terms of the characteristic of “perseverance. Also, if the average score for “perseverance” for a particular department of a company for a certain characteristic is 20, while the score for job seekers is 80, if that department seeks job seekers with a high “perseverance” characteristic, it may conversely approach job seekers with a low similarity. In this regard, this embodiment can provide material for making hiring decisions tailored to the circumstances of each recruiter by showing objective similarity.

Or, for example, for a group of employees in the sales department of a recruiter company, information about multiple job seekers is displayed, each with information about their similarity to the overall score of multiple characteristics, including “problem-solving skills,” “perseverance,” and so on. For example, if the overall score of all characteristics (average score of each characteristic) of a group of employees in the sales department is “80,” the job seeker with an overall score of “80” has a similarity of 100% and is considered to be highly similar. Here, information about the job seeker's similarity to the overall score, which is the sum or average of the scores of each characteristic of a group of employees who have good sales performance in the sales department and are considered high performers, can also be displayed. The information about job seekers can be sorted and displayed, for example, in order of newest or similarity. Here, similar to the above, job seekers with high similarity do not necessarily fit into a particular department of a recruiter. In particular, job seekers with an overall score of “100” are less similar to the above employee group in the sales department (“80”) than job seekers with a score of “80”. In addition, some recruiters have a need to hire job seekers who are different from the employee group trend (i.e., candidates with lower similarity). Thus, this embodiment calculates and presents the similarity between recruiters and job seekers using the overall score calculated as the sum or average score of the scores of each characteristic, thereby providing a material for making a hiring decision tailored to each recruiter's circumstances.

As described above, according to this embodiment, by objectively presenting the similarity between the recruiter's department group and the job seeker for each characteristic to the hiring manager, the hiring manager can make an objective hiring decision in light of the needs of each company.

As another example, as shown in FIG. 10, the user interface of the job seeker terminal 200 displays recruiters (companies and/or their departments) whose scores for the job seeker's characteristics are similar to the job seeker's scores for the job seeker's characteristics. The server terminal 100 receives a request from the job seeker terminal 200 to search for recruiters and provides information about a plurality of recruiters based on the similarity with respect to the score for each characteristic or the overall score for the plurality of characteristics calculated by the aptitude assessment unit 134, with information about the similarity for each of them. The information about recruiters can be sorted and displayed, for example, in order of new arrivals or similarity. According to this example, if a job seeker values “decision-making ability” more than he or she values “problem-solving ability” as a characteristic of himself/herself, he/she can look at a list of companies with high similarity in “decision-making ability” and approach companies with high similarity. Alternatively, when job seekers search for companies based on their overall score of multiple characteristics, they can approach companies that are similar to their overall score as companies that have employees with similar tendencies to them. They can also approach companies that are not similar to their overall score in order to take advantage of their own characteristics.

As another example, the server terminal 100 provides job seekers with, for example, “stability-oriented consultants” and “annual salary-oriented consultants” categories when matching them to job seekers. The server terminal 100 may also provide the job seeker in the category of “stability-oriented consultant” with information about stable companies (e.g., a Japanese company, with at least 1,000 employees, listed on the first section of the Tokyo Stock Exchange, established for at least 20 years, etc.), along with or instead of similarity based on the results of the aptitude test. Alternatively, the server terminal 100 may provide the job seeker with information about the selected recruiter as a “annual salary-oriented consultants” with the matching criteria being a company with a high annual salary (e.g., a foreign-owned company, a company that meets criteria such as executive treatment, stock option grants, etc.).

### Embodiment 2

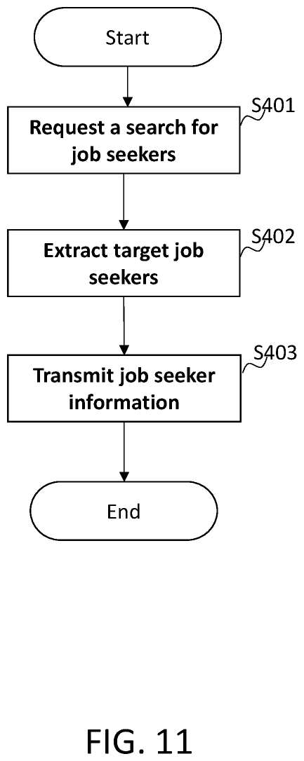

FIG. 11 is an example of a flowchart for a matching method, in accordance with the second embodiment of this invention.

Since the system providing the matching method in this embodiment can be made equivalent to the first embodiment, the explanation is omitted. In addition, in matching job seekers and recruiters, as a pre-processing step, an aptitude test is provided to each job seeker and recruiter, a score is calculated based on the response information received from each, and the score information of each job seeker and recruiter is updated. This point can be equivalent to the first embodiment shown in FIG. 6 and FIG. 7, so the explanation is omitted. In this embodiment, the matching process including the process in which a job seeker searches for a recruiter based on the score information of the job seeker and the recruiter obtained as a result of the above preprocessing is described below.

First, as shown in FIG. 11, in step S401, the instruction reception unit 131 of the server terminal 100 receives a request to search for job seekers from the recruits' terminal 300 via the communication unit 110. For example, through the user interface of the recruiter terminal 300, the recruiter enters the name of a specific department of the recruiter and makes a request to search for job seekers matching that department by a predetermined operation.

Next, as the process of step S402, the aptitude assessment unit 134 of the server terminal 100 extracts job seekers who satisfy the extraction conditions. For example, the aptitude assessment unit 134 refers to the aptitude information regarding employees in a specific department entered by the recruiter from the recruiter data 2000 in the recruiter data storage unit 122 and extracts the aptitude information of the employees in that department. Here, the extracted aptitude information includes the score for each employee in the department, and may also include a score for each characteristic, or an overall score as the sum or average of the scores for each characteristic. Here, the score may be the average, highest, and/or lowest score for the department. The aptitude information also includes scores for each of the high and low performer groups. Similarly, for example, the aptitude assessment unit 134 refers to the aptitude information for all or some job seekers from the job seeker data 1000 in the job seeker data storage unit 121 and extracts the aptitude information for each job seeker. The extracted aptitude information may include a job seeker's score for each characteristic, or an overall score as the sum or average of scores for each characteristic. The aptitude assessment unit 134 can then refer to the job seeker's score based on, for example, the overall score of the above mentioned department as the extraction condition, and extract job seekers whose overall score falls within a predetermined range. As a specific example, one or more job seekers with a score higher than the lowest overall score among the high performers of a specific department can be extracted. Or, one or more job seekers with an overall score above the lowest overall score and below the highest overall score among the high performers in a particular department can be selected. The upper limit may be aimed at extracting job seekers with similar scores to the high performers in a particular department, so that job seekers with similar characteristics to the high performers in a particular department can be extracted. Alternatively, a predetermined range of scores (e.g., between 60 and 80) can be set based on the lowest and highest overall scores of the high performers in a particular department, and job seekers who meet these criteria can be extracted.

Next, as the process of step S403, the matching processing unit 135 of the server terminal 100 transmits the information about the extracted job seeker to the recruiter terminal 300.

As described above, according to this embodiment, by presenting the job seekers extracted based on the scores of the recruiter's department group objectively for each characteristic to the hiring manager, the hiring manager can make an objective hiring decision in light of the needs of each company.

The above described embodiments of the disclosure can be implemented in various other forms, and can be implemented with various omissions, substitutions, and modifications. These embodiments and variations, as well as omissions, substitutions, and modifications, are included within the technical scope of the claims and their equivalents.

### DESCRIPTION OF REFERENCE NUMERALS

1 Matching system
100 Server terminal
110 Communication unit
120 Memory unit
130 Control unit
200 Job seeker terminal
300 Recruiter terminal
NW Network

1. A method of matching a job seeker with a recruiter provided by a system comprising:
a recruiter terminal associated with a recruiter;
a job seeker terminal associated with a job seeker, which is connected to the recruiter terminal via a network;
and a server terminal,
wherein the server terminal provides an aptitude test to the job seeker terminal and the recruiter terminal;
receives, from the recruiter's terminal and the job seeker's terminal, response information to the aptitude test;
calculates a score for each recruiter associated with the recruiter terminal and each job seeker associated with the job seeker terminal based on the response information;
responds to a search request for a job seeker from the recruiter's terminal; and
extracts job seekers satisfying the predetermined conditions by referring to the job seeker's score based on the recruiter's score.

2. The method of matching according to claim 1,
wherein the recruiter's score is the score of an employee belonging to a specific department of the recruiter.

3. The method of matching according to claim 1,
wherein the recruiter's score is the score of a high performer among the employees belonging to a particular department of the recruiter.

4. The method of matching according to claim 1,
wherein the predetermined condition is a minimum score of the recruiter's score.

5. The method of matching according to claim 1,
wherein the predetermined condition is a score of the recruiter that is greater than or equal to the lowest score and less than or equal to the highest score of the recruiter.
